(19) United States
(12) Patent Application Publication
(10) Pub. No.: US 2020/0097579 A1
(43) Pub. Date: Mar. 26, 2020

(54) DETECTING ANOMALOUS TRANSACTIONS IN COMPUTER LOG FILES

(71) Applicant: CA, Inc., New York, NY (US)

(72) Inventors: Sharath Bagivalu MANJAPPA, Karnataka (IN); Anil JOSEPH, Bangalore (IN); Sanjay RAI, Bengaluru, Karnataka (IN); Stephen PRASAD, Karnataka (IN)

(73) Assignee: CA, Inc.

(21) Appl. No.: 16/136,609

(22) Filed: Sep. 20, 2018

(51) Int. Cl. G06F 17/30

(52) U.S. Cl. CPC G06F 17/30377; G06F 17/30144

(57) ABSTRACT

A method of detecting anomalous transactions in computer network log files includes obtaining an event log file that includes a plurality of lines of log output associated with respective transactions, obtaining a log entry pattern for a transaction type, the log entry pattern including a plurality of log entries associated with normal behavior of transactions of the transaction type, identifying a plurality of log entries associated with a transaction of the transaction type, comparing the plurality of log entries to the log entry pattern, and determining that the transaction is an anomalous transaction in response to the comparison.

### BACKGROUND

The present disclosure relates to computer networks, and in particular to the processing of transaction log files generated in distributed computing systems.

Log files may be generated in computer networks for a number of reasons. For example, log files may be generated by applications to keep records of errors or warnings that the application encounters. Operating systems keep multiple log files to record events that occur in a computer system. Network devices keep log files of network events.

Some distributed computing systems process transactions and keep log files that record transaction events, such as the initiation of a transaction, processing events that occur as part of the transaction, error conditions, warnings, and transaction outcomes. Such log files can be a valuable resource to network administration systems that manage distributed computing systems.

### SUMMARY

A method of detecting anomalous transactions in computer network log files according to some embodiments includes obtaining an event log file of events in a computer network, wherein the event log file includes a plurality of lines of log output, each of the plurality of lines associated with a respective transaction in the computer network, wherein more than one log entry can be associated with a single transaction in the computer network, obtaining a log entry pattern for a first transaction type, the log entry pattern including a plurality of log entries associated with normal behavior of transactions of the first transaction type, identifying a plurality of log entries in the event log file associated with a first transaction of the first transaction type, comparing the plurality of log entries in the event log file associated with the first transaction to the log entry pattern, and determining that the first transaction is an anomalous transaction in response to the comparison of the plurality of log entries in the event log file associated with the first transaction to the log entry pattern.

The method may further include generating a similarity metric between the plurality of log entries in the event log file associated with the first transaction and the log entry pattern, and reporting the first transaction to a network management system in response to the similarity metric being less than a threshold level.

The method may further include generating a predicted frequency of anomalous transactions based on determining that the first transaction is an anomalous transaction.

Comparing the plurality of log entries in the event log file associated with the first transaction to the log entry pattern may include comparing a first line in the log entry pattern to a line in the event log file, in response to finding a line in the event log file that corresponds to the first line in the log entry pattern, determining a unique transaction identifier associated with a transaction for which the line in the event log file was generated, and scanning the event log file to identify all event log entries in the event log file associated with the first transaction based on the unique transaction identifier.

The method may further include comparing subsequent lines in the log entry pattern to identified event log entries associated with the first transaction.

The method may further include reporting the first transaction to a network management system in response to determining that the first transaction is an anomalous transaction.

The plurality of log entries may be associated with the first transaction are not sequential within the event log file.

The method may further include scanning the event log file to identify sets of log entries associated with a plurality of transactions of the first transaction type, and generating the log entry pattern based on the identified sets of log entries, wherein the log entry pattern represents an expected system behavior for transactions of the first transaction type.

The log entry pattern may represent an average system behavior for transactions of the first transaction type or a non-exceptional system behavior for transactions of the first transaction type.

The method may further include generating a plurality of log entry patterns based on the identified sets of log entries, wherein the plurality of log entry patterns collectively represent expected system behavior for transactions of the first transaction type.

The method may further include determining whether the first transaction was successful, and in response to determining that the first transaction was not successful, determining if a failure of the first transaction is associated with a system error.

A network management server for detecting anomalies in computer network log files according to some embodiments includes a processor circuit, and a memory coupled to the processor circuit. The memory includes computer readable program instructions that cause the processor circuit to obtain an event log file of events in a computer network, wherein the event log file includes a plurality of lines of log output, each of the plurality of lines associated with a respective transaction in the computer network, wherein more than one log entry can be associated with a single transaction in the computer network, obtain a log entry pattern for a first transaction type, the log entry pattern including a plurality of log entries associated with normal behavior of transactions of the first transaction type, identify a plurality of log entries in the event log file associated with a first transaction of the first transaction type, compare the plurality of log entries in the event log file associated with the first transaction to the log entry pattern, and determine that the first transaction is an anomalous transaction in response to the comparison of the plurality of log entries in the event log file associated with the first transaction to the log entry pattern.

A method of detecting anomalous transactions in computer network log files according to further embodiments includes obtaining an event log file of events in a computer network, wherein the event log file includes a plurality of lines of log output, each of the plurality of lines associated with a respective transaction in the computer network, wherein more than one log entry can be associated with a single transaction in the computer network, identifying log entries in the event log file associated with a plurality of transactions of a first transaction type, generating, from the log entries, a log entry pattern for the first transaction type, the log entry pattern including a plurality of generic log entries associated with normal behavior of transactions of the first transaction type, comparing a plurality of log entries in the event log file associated with a first transaction of the first transaction type to the log entry pattern, and determining that the first transaction is an anomalous transaction in response to the comparison of the plurality of log entries in the event log file associated with the first transaction to the log entry pattern.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2 is a block diagram of a transaction log analysis system according to some embodiments of the inventive concepts.

FIG. 3 is a flowchart illustrating operations of systems/methods in accordance with some embodiments of the inventive concepts.

FIGS. 4, 5 and 6 illustrate examples of comparing actual transaction records to expected patterns and generating similarity metrics for the transactions according to some embodiments of the inventive concepts.

FIG. 7 is a block diagram of a computing system which can be configured as a network management system according to some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

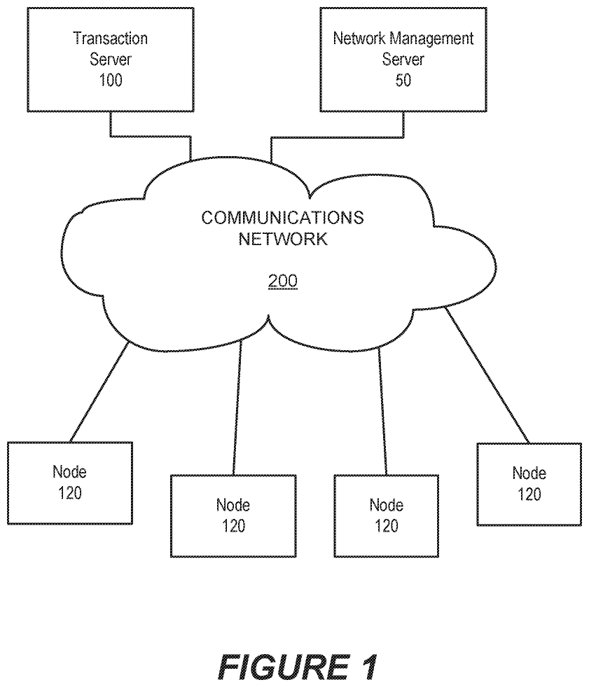

FIG. 1 is a block diagram of a network computing environment in which systems/methods according to embodiments of the inventive concepts may be employed. Referring to FIG. 1, a plurality of nodes 120 access a transaction server 100 through a communications network 200.

The nodes 120 and the transaction server 100 may be physical networked computing devices that have processors and associated resources, such as memory, storage, communication interfaces, etc., or virtual machines that have virtual resources assigned by a virtual hypervisor. In particular, the nodes 120 may represent client devices that initiate transactions in the transaction server 100. The transaction server 100 receives transaction requests from the nodes 120, processes the transactions, and reports the result of the transaction to the requesting node. For example, the transaction server 100 may be a credit card transaction server that validates credit card transactions.

The transaction server 100 may store log entries of events that occur during the processing of a transaction in a transaction event log. Each log entry in the transaction event log may include a date stamp, a transaction identifier (transaction ID) and a text field that contains a description of the log entry. For example, a sample log record is shown below for a transaction event log related to a transaction having a transaction ID of “unique-thread-1.” The text field of the log entry indicates that the transaction has been initiated.
2018-05-07 11:00:06,641 unique-thread-1 Transaction initiated . . .

As the transaction “unique-thread-1” is being processed, the transaction server 100 may generate a number of related log entries. For example, in the course of completing the transaction, the transaction server 100 may generate the following log entries related to the transaction (the collection of log entries or log lines that relate to a single transaction is referred to herein as a “transaction record”):
2018-05-07 11:00:06,641 unique-thread-1 Transaction initiated . . .
2018-05-07 11:00:07,988 unique-thread-1 Transaction details getting validated . . .
2018-05-07 11:01:13,543 unique-thread-1 Transaction being processed . . .
2018-05-07 11:02:16,452 unique-thread-1 Transaction Success . . .

In a production environment, a transaction server 100 may process may hundreds or even thousands of transactions concurrently. As each transaction requires a finite amount of time to complete, many recordable events may be occurring very close together in time. Transaction log entries are typically written in chronological order, e.g., as the events they represent occur. Thus, the transaction log may include transaction log entries relating to multiple transactions that are interspersed with one another, such as shown below. The log entries shown below relate to two concurrent transactions, namely, a transaction having transaction ID “unique-thread-1” and a transaction having transaction ID “unique-thread-2.” The log entries for the two transactions are interspersed with one another. That is, the first transaction (“unique-thread-1”) is initiated, and then the second transaction (“unique-thread-2”) is initiated before the first transaction is completed.
2018-05-07 11:00:06,641 unique-thread-1 Transaction initiated . . .
2018-05-07 11:00:06,641 unique-thread-2 Transaction initiated . . .
2018-05-07 11:00:07,988 unique-thread-1 Transaction details getting validated . . .
2018-05-07 11:01:13,543 unique-thread-1 Transaction being processed . . .
2018-05-07 11:01:14,934 unique-thread-2 Transaction has warnings. Getting validated . . .
2018-05-07 11:02:16,452 unique-thread-1 Transaction Success . . .
2018-05-07 11:09:16,564 unique-thread-2 Transaction Success . . .

For a given type of transaction, there may be an expected pattern of transaction log entries (or log lines). For example, as shown above, a transaction for a particular type of service may have the following pattern of entries:
[time stamp] [transaction ID] Transaction initiated . . .
[time stamp] [transaction ID] Transaction details getting validated . . .
[time stamp] [transaction ID] Transaction being processed . . .
[time stamp] [transaction ID] Transaction Success . . .

A network administrator may be interested in identifying transactions that do not follow an expected sequence of transaction entries. Such transactions are referred to herein as “anomalous transactions.” It may be easy for the network administrator to identify a failed transaction, as there will be a log entry that indicates transaction failure, and the network administrator may find the transaction using a simple text search. More sophisticated searching tools are available (e.g., ELK, Splunk etc.) that allow network administrators to perform rigorous searches in logs. Searches made using these tools are typically based on generalized templates or text strings provided by the user. However, it may be difficult and/or burdensome to use these tools to identify anomalous transactions, that is, transactions with unexpected patterns of transaction log entries, as opposed to simply finding failed transactions.

Some embodiments provide systems/methods that search for anomalous patterns in transaction log entries. The systems/methods may flag anomalous transactions when they are identified, and may provide additional information about the transaction, such as how much the transaction record deviates from an expected transaction record pattern. Systems/methods according to some embodiments may first identify expected transaction record patterns, for example, from previously recorded transaction logs, and, as opposed to searching for particular strings in the transaction event log associated with irregular or anomalous transactions, the systems/methods search for transaction records that do not follow the expected transaction record pattern or patterns, and report the existence of such transaction records. That is, systems/methods according to some embodiments invert the conventional approach to searching such that the systems/methods use the expected behavior as an input to the search tool and, by comparing the expected behavior of transactions to the actual behavior of transactions, identify transaction log patterns that do not match the expected behavior.

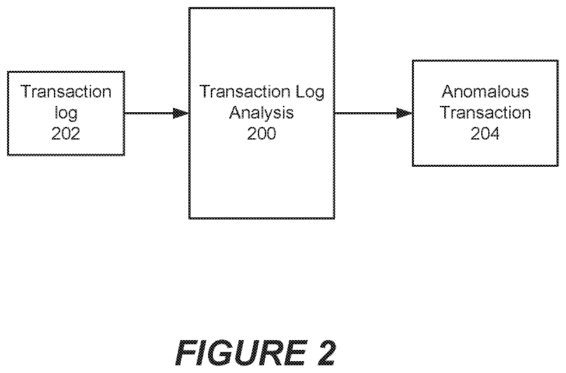

FIG. 2 is a block diagram of a transaction log analysis system according to some embodiments of the inventive concepts. Referring to FIG. 2, a transaction log analysis system 200 may receive as input a transaction log 202 containing a plurality of transaction log entries that relate to multiple transactions. The transaction log analysis system may in some embodiments receive log entries in real time as (or substantially nearly as) they are being written to the transaction log 202. In other embodiments, the transaction log analysis system 200 may process previously stored transaction logs. The transaction log analysis system 200 analyzes the log entries in the transaction log as described herein and, based on such analysis, may identify one or more anomalous transactions 204, which are transactions that do not follow an expected pattern of log entries for the type of transaction in question.

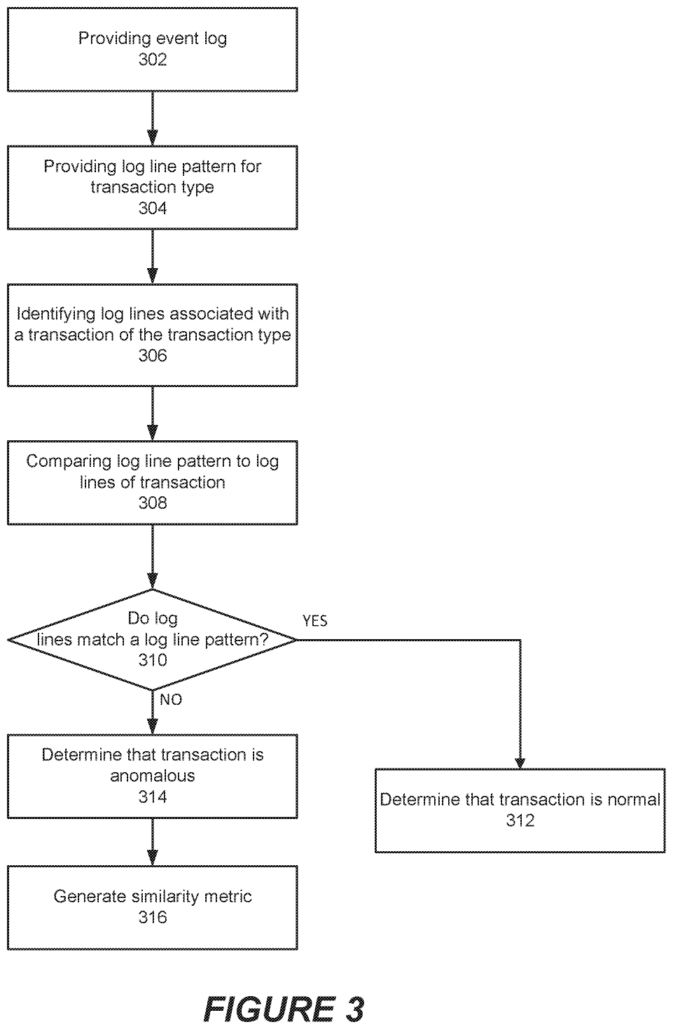

FIG. 3 is a flowchart illustrating operations of systems/methods in accordance with some embodiments of the inventive concepts. Referring to FIG. 3, the operations include providing an event log file of events in a computer network (block 302). The event log file includes a plurality of lines of log output, where each of the plurality of lines is associated with a respective transaction in the computer network. More than one log entry in the event log can be associated with a single transaction in the computer network, and the event log contains log entries for multiple transactions.

The methods further include providing a log entry pattern for a first transaction type (block 304). The log entry pattern includes a plurality of log entries associated with normal behavior of transactions of the first transaction type.

The methods then identify a plurality of log entries in the event log file associated with a first transaction of the first transaction type (block 306), and compare the plurality of log entries in the event log file associated with the first transaction to the log entry pattern (block 308).

The methods determine whether or not the first transaction is an anomalous transaction by comparing the plurality of log entries in the event log file associated with the first transaction to the log entry pattern and determining if the log entries in the event log file associated with the first transaction match the log entry pattern (block 310). If the log entries do not patch the pattern, the comparison may determine a level or percentage by which the log entries differ from the pattern. In response to the comparison, the methods may determine that the transaction is normal (block 312) or anomalous (block 314). If the transaction is anomalous, a similarity metric may be generated that provides a measure of how much the actual transaction differs from the expected pattern (block 316). If the similarity metric is less than a predetermined threshold, the transaction may be flagged for review. In addition, a record may be generated of the finding for subsequent statistical analysis of the findings.

The method may further include generating a similarity metric between the plurality of log entries in the event log file associated with the first transaction and the log entry pattern, and reporting the first transaction to a network management system in response to the similarity metric being less than a threshold level. The similarity metric may indicate a percentage match between the log entries in the event log file associated with the first transaction and the log entry pattern, and may be calculated as described below.

The method may further include generating a predicted frequency of anomalous transactions based on determining that the first transaction is an anomalous transaction. For example, a log file may be analyzed to identify anomalous transactions, and an anomaly rate may be calculated for transactions of a particular transaction type as a percentage using the formula:

$$Anomaly rate = \frac{No . of anomalous transactions}{Total no . of transactions} \times 100 \qquad [ 1 ]$$

Each transaction entry may include a unique transaction identifier that can be used to identify other entries corresponding to the same transaction. Thus, the method may include comparing a first line in the log entry pattern to a line in the event log file, in response to finding a line in the event log file that corresponds to the first line in the log entry pattern, determining a unique transaction identifier associated with a transaction for which the line in the event log file was generated, and scanning the event log file to identify all event log entries in the event log file associated with the first transaction based on the unique transaction identifier.

The method may compare subsequent lines in the log entry pattern to identified event log entries associated with the first transaction. The plurality of log entries associated with a particular transaction may not appear sequentially within the event log file.

When an anomalous transaction is found, the transaction may be reported to a network management system.

In some embodiments, log entry patterns may be generated by analyzing a log file. Thus, in some embodiments, the method may further include scanning the event log file to identify sets of log entries associated with a plurality of transactions of the first transaction type, and generating the log entry pattern based on the identified sets of log entries, wherein the log entry pattern represents an expected system behavior for transactions of the first transaction type.

A log entry pattern may represent an average system behavior for transactions of the first transaction type or a non-exceptional system behavior for transactions of the first transaction type. There may be multiple log entry patterns for transactions of a particular type. For example, for a given of transaction, there may be several patterns of entries that reflect normal or expected behavior for that type of transaction.

The method may further include generating a plurality of log entry patterns based on the identified sets of log entries, wherein the plurality of log entry patterns collectively represent expected system behavior for transactions of the first transaction type.

The method may further include determining whether the first transaction was successful, and in response to determining that the first transaction was not successful, determining if a failure of the first transaction is associated with a system error.

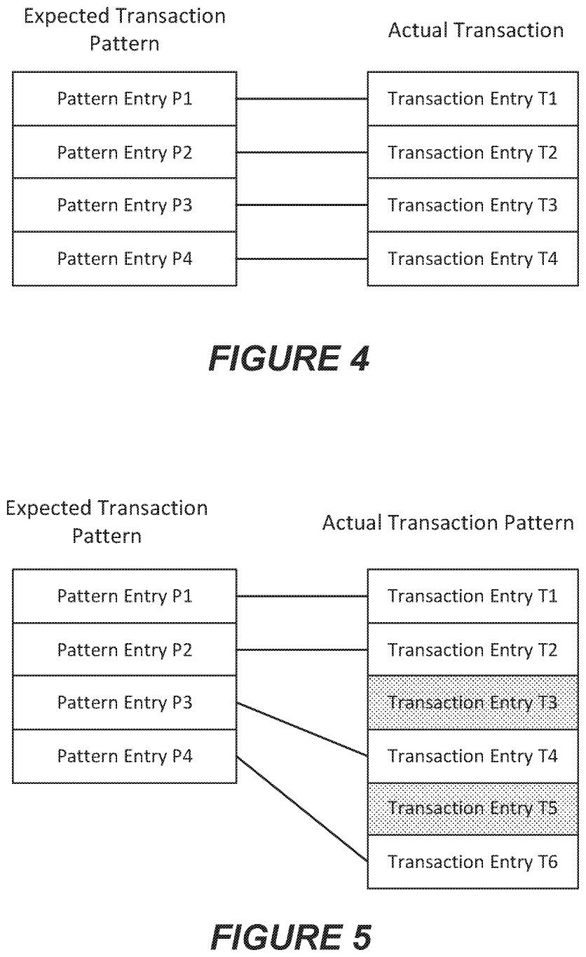

FIGS. 4 to 6 illustrate examples of comparing actual transaction records to expected patterns and generating similarity metrics for the transactions. FIG. 4 illustrates an example in which an expected transaction pattern (shown on the left) has four entries, namely, pattern entries P1 to P4. A transaction extracted from the event log is also found to have four entries, namely, transaction entries T1 to T4, shown on the right side. According to some embodiments, the actual transaction is examined to determine if the transaction entries in the expected transaction pattern are present in the actual transaction entries, and vice versa. In addition, the transaction entries in the actual transaction that correspond to transaction entries in the expected transaction pattern are examined to determine if they occur in the same order as the corresponding entries in the expected transaction pattern. For example, the entry in the transaction corresponding to pattern entry P2 should occur after the entry in the transaction corresponding to pattern entry P1 and before the entry in the transaction corresponding to pattern entry P3.

In FIG. 4, a line connects each entry in the expected transaction pattern with the corresponding entry in the actual transaction. In this example, each entry in the expected transaction pattern has a corresponding entry in the actual transaction, and vice-versa.

A value or score may be assigned for each matching entry and for each entry that occurs in the expected order. For the example shown in FIG. 4, the results of such analysis are shown in Table 1, below, where 1 point is added for each pattern entry in the expected transaction that is present in the actual transaction, 1 point is added for each transaction entry that is found in the expected transaction pattern, and 1 point is added for each transaction entry that occurs in the order of transaction entries shown in the expected transaction pattern. In the example, of FIG. 4, because the expected transaction pattern has four entries, a total of 12 points can be assigned. A percentage match score can be calculated based on the ratio of the total points assigned to the total points available. The foregoing is an example only, and the factors can be weighted differently than shown. The result generated for the example in FIG. 4 is shown in Table 1, below, and indicates a 100% match.

TABLE 1
First Example

| Expected Transaction Entry | Found in Transaction | |
|---|---|---|
| P1 | 1 | |
| P2 | 1 | |
| P3 | 1 | |
| P4 | 1 | |
| Subtotal | 4 | |
| Actual Transaction Entry | Found in Expected Pattern | In order |
| T1 | 1 | 1 |
| T2 | 1 | 1 |
| T3 | 1 | 1 |
| T4 | 1 | 1 |
| Subtotal | 4 | 4 |
| Total Score | 12 | |
| Percent Match | 100% | |

FIG. 5 illustrates an example in which the actual transaction record has extra entries that are not found in the expected transaction pattern. As shown in FIG. 5, the expected transaction pattern (shown on the left) again has four entries, namely, pattern entries P1 to P4, but a transaction extracted from the event log is found to have six entries, namely, transaction entries T1 to T6, shown on the right side.

According to some embodiments, the actual transaction is examined to determine if the transaction entries in the expected transaction pattern are present in the actual transaction entries, and vice versa. As in FIG. 4, a line connects each entry in the expected transaction pattern with the corresponding entry in the actual transaction. In this example, each entry in the expected transaction pattern has a corresponding entry in the actual transaction. However, transaction entries T3 and T5 in the transaction do not have corresponding entries in the expected transaction pattern. For such entries, a score of −1 may be recorded.

In the example, of FIG. 5, because the expected transaction pattern has four entries, a total of 12 points can be assigned. A percentage match score can be calculated based on the ratio of the total points assigned to the total points available. The result generated for the example in FIG. 5 is shown in Table 2, below, and indicates a match of 83.3%.

TABLE 2
Second Example

| Expected Transaction Entry | Found in Transaction | |
|---|---|---|
| P1 | 1 | |
| P2 | 1 | |
| P3 | 1 | |
| P4 | 1 | |
| Subtotal | 4 | |
| Actual Transaction Entry | Found in Expected Pattern | In order |
| T1 | 1 | 1 |
| T2 | 1 | 1 |
| T3 | −1 | 0 |
| T4 | 1 | 1 |
| T5 | −1 | 0 |
| T6 | 1 | 1 |
| Subtotal | 2 | 4 |
| Total Score | 10 | |
| Percent Match | 83.3% | |

Note that in this example, although transaction entries T3 and T5 are unexpectedly present, entry T4 (corresponding to pattern entry P3) follows entry T2 (corresponding to pattern entry P2), and entry T6 (corresponding to pattern entry P4) follows entry T4 (corresponding to pattern entry P3). Thus, the “in order” score for each such entry is 1.

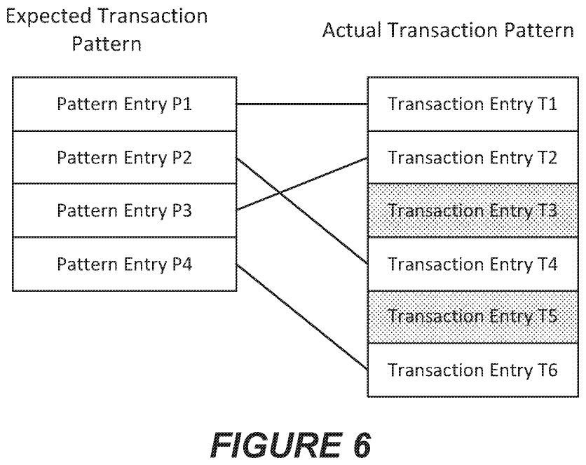

FIG. 6 illustrates an example in which the actual transaction record has extra entries that are not found in the expected transaction pattern and transactions are out of order. As shown in FIG. 6, the expected transaction pattern (shown on the left) again has four entries, namely, pattern entries P1 to P4, but a transaction extracted from the event log is found to have six entries, namely, transaction entries T1 to T6, shown on the right side.

According to some embodiments, the actual transaction is examined to determine if the transaction entries in the expected transaction pattern are present in the actual transaction entries, and vice versa. As in FIGS. 4 and 5, a line connects each entry in the expected transaction pattern with the corresponding entry in the actual transaction. In this example, each entry in the expected transaction pattern has a corresponding entry in the actual transaction. However, transaction entries T3 and T5 in the transaction do not have corresponding entries in the expected transaction pattern. For such entries, a score of −1 may be recorded.

Transactions T4 and T2 are also reversed in order from the expected pattern. In such case, 1 point may be deducted if the transaction entry does not fall in the expected order.

In the example, of FIG. 6, because the expected transaction pattern has four entries, a total of 12 points can be assigned. A percentage match score can be calculated based on the ratio of the total points assigned to the total points available. The result generated for the example in FIG. 6 is shown in Table 2, below, and indicates a match of 83.3%.

TABLE 3
Third Example

| Expected Transaction Entry | Found in Transaction | |
|---|---|---|
| P1 | 1 | |
| P2 | 1 | |
| P3 | 1 | |
| P4 | 1 | |
| Subtotal | 4 | |
| Actual Transaction Entry | Found in Expected Pattern | In order |
| T1 | 1 | 1 |
| T2 | 1 | 0 |
| T3 | −1 | 0 |
| T4 | 1 | 0 |
| T5 | −1 | 0 |
| T6 | 1 | 1 |
| Subtotal | 2 | 2 |
| Total Score | 8 | |
| Percent Match | 66.6% | |

Note that in this example, entry T4 (corresponding to pattern entry P3) precedes entry T2 (corresponding to pattern entry P2). Thus, the “in order” score for each such entry is 0.

Other methods of comparing actual transaction entries with expected transaction entries may be employed in various embodiments of the inventive concepts.

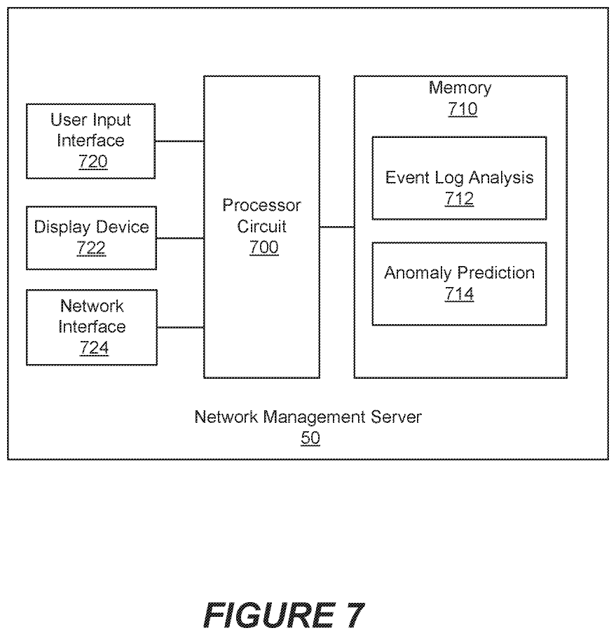

FIG. 7 is a block diagram of a network management server 50 that can be configured to perform operations according to some embodiments of the inventive concepts. The network management server 50 includes a processor 700, a memory 710, and a network interface 724, which may include a radio access transceiver and/or a wired network interface (e.g., Ethernet interface).

The processor 700 may include one or more data processing circuits, such as a general purpose and/or special purpose processor (e.g., microprocessor and/or digital signal processor) that may be collocated or distributed across one or more networks. The processor 700 is configured to execute computer program code in the memory 710, described below as a non-transitory computer readable medium, to perform at least some of the operations described herein. The network management server 50 may further include a user input interface 720 (e.g., touch screen, keyboard, keypad, etc.) and a display device 722.

The memory 710 includes computer readable code that configures the network management server 50 to implement event log analysis function described herein. In particular, the memory 710 includes event log analysis code 712 that configures the network management server 50 to analyze event logs to identify anomalous transactions and anomaly prediction code 714 that configures the network management server 50 to predict future anomalous behavior of the computer system.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of detecting anomalous transactions in computer network log files, comprising:
obtaining an event log file of events in a computer network, wherein the event log file comprises a plurality of lines of log output, each of the plurality of lines associated with a respective transaction in the computer network, wherein more than one log entry can be associated with a single transaction in the computer network;
obtaining a log entry pattern for a first transaction type, the log entry pattern comprising a plurality of log entries associated with normal behavior of transactions of the first transaction type;
identifying a plurality of log entries in the event log file associated with a first transaction of the first transaction type;
comparing the plurality of log entries in the event log file associated with the first transaction to the log entry pattern; and
determining that the first transaction is an anomalous transaction in response to the comparison of the plurality of log entries in the event log file associated with the first transaction to the log entry pattern.

2. The method of claim 1, further comprising:
generating a similarity metric between the plurality of log entries in the event log file associated with the first transaction and the log entry pattern; and
reporting the first transaction to a network management system in response to the similarity metric being less than a threshold level.

3. The method of claim 1, further comprising:
generating a predicted frequency of anomalous transactions based on determining that the first transaction is an anomalous transaction.

4. The method of claim 1, wherein comparing the plurality of log entries in the event log file associated with the first transaction to the log entry pattern comprises:
comparing a first line in the log entry pattern to a line in the event log file;
in response to finding a line in the event log file that corresponds to the first line in the log entry pattern, determining a unique transaction identifier associated with a transaction for which the line in the event log file was generated; and
scanning the event log file to identify all event log entries in the event log file associated with the first transaction based on the unique transaction identifier.

5. The method of claim 4, further comprising:
comparing subsequent lines in the log entry pattern to identified event log entries associated with the first transaction.

6. The method of claim 1, further comprising:
reporting the first transaction to a network management system in response to determining that the first transaction is an anomalous transaction.

7. The method of claim 1, wherein the plurality of log entries associated with the first transaction are not sequential within the event log file.

8. The method of claim 1, further comprising:
scanning the event log file to identify sets of log entries associated with a plurality of transactions of the first transaction type; and
generating the log entry pattern based on the identified sets of log entries, wherein the log entry pattern represents an expected system behavior for transactions of the first transaction type.

9. The method of claim 8, wherein the log entry pattern represents an average system behavior for transactions of the first transaction type.

10. The method of claim 8, wherein the log entry pattern represents a non-exceptional system behavior for transactions of the first transaction type.

11. The method of claim 8, further comprising:
generating a plurality of log entry patterns based on the identified sets of log entries, wherein the plurality of log entry patterns collectively represent expected system behavior for transactions of the first transaction type.

12. The method of claim 1, further comprising determining whether the first transaction was successful, and
in response to determining that the first transaction was not successful, determining if a failure of the first transaction is associated with a system error.

13. A network management server for detecting anomalies in computer network log files, the network management server comprising:
a processor circuit; and
a memory coupled to the processor circuit and comprising computer readable program instructions that cause the processor circuit to:
obtain an event log file of events in a computer network, wherein the event log file comprises a plurality of lines of log output, each of the plurality of lines associated with a respective transaction in the computer network, wherein more than one log entry can be associated with a single transaction in the computer network;
obtain a log entry pattern for a first transaction type, the log entry pattern comprising a plurality of log entries associated with normal behavior of transactions of the first transaction type;
identify a plurality of log entries in the event log file associated with a first transaction of the first transaction type;
compare the plurality of log entries in the event log file associated with the first transaction to the log entry pattern; and
determine that the first transaction is an anomalous transaction in response to the comparison of the plurality of log entries in the event log file associated with the first transaction to the log entry pattern.

14. The network management server of claim 13, wherein the computer readable program instructions further cause the processor circuit to:
generate a similarity metric between the plurality of log entries in the event log file associated with the first transaction and the log entry pattern; and
report the first transaction to a network management system in response to the similarity metric being less than a threshold level.

15. The network management server of claim 13, wherein the computer readable program instructions further cause the processor circuit to:
generate a predicted frequency of anomalous transactions based on determining that the first transaction is an anomalous transaction.

16. The network management server of claim 13, wherein comparing the plurality of log entries in the event log file associated with the first transaction to the log entry pattern comprises:
comparing a first line in the log entry pattern to a line in the event log file;
in response to finding a line in the event log file that corresponds to the first line in the log entry pattern, determining a unique transaction identifier associated with a transaction for which the line in the event log file was generated; and
scanning the event log file to identify all event log entries in the event log file associated with the first transaction based on the unique transaction identifier.

17. The network management server of claim 16, wherein the computer readable program instructions further cause the processor circuit to:
comparing subsequent lines in the log entry pattern to identified event log entries associated with the first transaction.

18. The network management server of claim 13, wherein the computer readable program instructions further cause the processor circuit to:
scan the event log file to identify sets of log entries associated with a plurality of transactions of the first transaction type; and
generate the log entry pattern based on the identified sets of log entries, wherein the log entry pattern represents an expected system behavior for transactions of the first transaction type.

19. The network management server of claim 18, wherein the computer readable program instructions further cause the processor circuit to:
generate a plurality of log entry patterns based on the identified sets of log entries, wherein the plurality of log entry patterns collectively represent expected system behavior for transactions of the first transaction type.

20. A method of detecting anomalous transactions in computer network log files, comprising:
obtaining an event log file of events in a computer network, wherein the event log file comprises a plurality of lines of log output, each of the plurality of lines associated with a respective transaction in the computer network, wherein more than one log entry can be associated with a single transaction in the computer network;
identifying log entries in the event log file associated with a plurality of transactions of a first transaction type;
generating, from the log entries, a log entry pattern for the first transaction type, the log entry pattern comprising a plurality of generic log entries associated with normal behavior of transactions of the first transaction type;
comparing a plurality of log entries in the event log file associated with a first transaction of the first transaction type to the log entry pattern; and
determining that the first transaction is an anomalous transaction in response to the comparison of the plurality of log entries in the event log file associated with the first transaction to the log entry pattern.
